(19) United States
(12) Patent Application Publication
(10) Pub. No.: US 2020/0020121 A1
(43) Pub. Date: Jan. 16, 2020

(54) DIMENSION ESTIMATING SYSTEM AND METHOD FOR ESTIMATING DIMENSION OF TARGET VEHICLE

(71) Applicant: DENSO International America, Inc., Southfield, MI (US)

(72) Inventors: Zaydoun RAWASHDEH, Farmington, MI (US); Rajesh MALHAN, Troy, MI (US)

(21) Appl. No.: 16/295,352

(22) Filed: Mar. 7, 2019

Related U.S. Application Data
(60) Provisional application No. 62/697,660, filed on Jul. 13, 2018.

(51) Int. Cl. G06T 7/60; H04W 4/40; G06K 9/62; G06T 7/50; G06T 7/20; G06T 7/70; G06K 9/00

(52) U.S. Cl. CPC G06T 7/60; H04W 4/40; G06K 9/6267; G06T 7/50; G06T 7/20; G06T 7/70; G06T 2207/10044; G06T 2207/30252; G06T 2207/20081; G06K 2209/23; G06T 2207/10004; G06T 2207/10028; G06K 9/00791

(57) ABSTRACT

The present disclosure provides a dimension estimating system for a host vehicle. The dimension estimating system includes an image sensor and a dimension estimator. The image sensor obtains image data of at least one side of a target vehicle around the host vehicle. The dimension estimator estimates, through a machine learning algorithm, a dimension of the target vehicle based on the image data of the one side of the target vehicle obtained by the image sensor.

### CROSS-REFERENCE TO RELATED APPLICATIONS

This application claims the benefit of U.S. Provisional Application No. 62/697,660 filed on Jul. 13, 2018. The entire disclosures of each of these provisional patent applications are incorporated herein by reference.

### TECHNICAL FIELD

The present disclosure relates to a dimension estimating system and a method for estimating a dimension of a target vehicle.

### BACKGROUND

Vehicles have on-board sensors to detect surrounding moving objects (e.g., vehicles, bicycles, trucks, etc.) in order to obtain positional, dimensional, and motion information regarding the detected objects. Such information may be shared with other remote vehicles via V2V and/or V2X communication.

However, there may be some difficulty in obtaining an accurate dimension and its center position of a moving object. For example, when the host vehicle visually captures a preceding vehicle by an on-board camera, the host vehicle is not able to obtain the length of the preceding vehicle since the camera only recognizes the rear view of the preceding vehicle. As a result, it would be difficult to obtain accurate dimensional information of an object surrounding the host vehicle.

In view of the above, it is an objective to provide a system and a method to obtain accurate dimensional information of a target vehicle surrounding a host vehicle.

### SUMMARY

This section provides a general summary of the disclosure, and is not a comprehensive disclosure of its full scope or all of its features.

A first aspect of the present disclosure provides a dimension estimating system for a host vehicle. The dimension estimating system includes an image sensor and a dimension estimator. The image sensor obtains image data of at least one side of a target vehicle around the host vehicle. The dimension estimator estimates, through a machine learning algorithm, a dimension of the target vehicle based on the image data of the one side of the target vehicle obtained by the image sensor.

A second aspect of the present disclosure provides a method for estimating a dimension of a target vehicle around a host vehicle. The method includes obtaining, with an image sensor, image data of at least one side of the target vehicle, and estimating, with a dimension estimator, a dimension of the target vehicle based on the image data of the one side of the target vehicle using a machine learning algorithm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. In the drawings:

FIG. 1 is a block diagram of a system according to one embodiment;

FIG. 2 is a flowchart schematically illustrating the entire dimension extracting process based on input images;

FIG. 3 is a diagram illustrating an exemplary situation where a host vehicle detects target vehicles and shares information thereof with a remote vehicle;

FIG. 4A is a flowchart illustrating a first network of the deep learning algorithm;

FIG. 4B is a flowchart illustrating a second network of the deep learning algorithm;

FIG. 4C is an image of a lookup table stored in a memory;

FIG. 5 is a schematic diagram to describe mathematical process of calculating a center position of a target vehicle;

FIG. 6 is a diagram illustrating a structure of a BSM;

FIG. 7 is a flowchart of an entire process executed by a processing unit; and

FIG. 8 is a situation where the host vehicle shares information of the target vehicle with a remote vehicle.

### DETAILED DESCRIPTION

In the following description, a dimension estimating system and a method for estimating a dimension of a target vehicle will be described. In the following embodiments, the dimension estimating system and the method will be employed together with a dedicated short range communications (DSRC) system. Then, the system and method will provide dimensional, positional, and motion information to the DSRC system, and the DSRC system will share the information with other vehicles. It should be noted that any type of Vehicle-to-Vehicle (V2V) and Vehicle-to-Infrastructure (V2X) communications which allow the host vehicle HV to communicate with other remote vehicle RVs and road infrastructures may be used for the present disclosure.

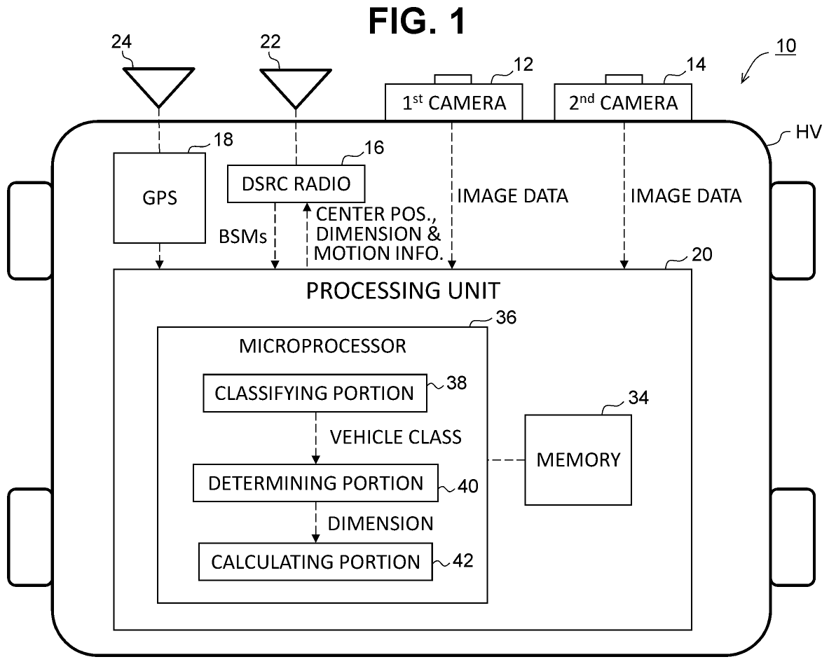

FIG. 1 shows a block diagram illustrating a system 10 mounted to a host vehicle HV. The system 10 generally includes a first camera (distance measuring sensor) 12, a second camera (an image sensor) 14, a DSRC radio 16, a global positioning system (GPS) 18, and a processing unit 20. The host vehicle HV is also equipped with a DSRC antenna 22 and a GPS antenna 24.

The DSRC antenna 22 and the DSRC radio 16 are mounted on, for example, a windshield or roof of the host vehicle HV. The DSRC radio 16 is configured to transmit/receive, through the DSRC antenna 22, messages to/from remote vehicle RVs and infrastructures (Road Side Units (RSU)) around the host vehicle HV. More specifically, the DSRC radio 16 transmits/receives successively basic safety messages (BSMs) to/from remote vehicle RVs equipped with similar DSRC systems over V2V (Vehicle-to-Vehicle) communications and/or V2X (Vehicle-to-Infrastructure) communications. In this embodiment, messages transmitted from the DSRC radio 16 include positional, dimensional, and motion information of target vehicles TV, as will be described in detail later.

The GPS antenna 24 is mounted on, for example, the windshield or roof of the host vehicle HV. The GPS 18 is connected to the GPS antenna 24 to receive positional information of the host vehicle HV from a GPS satellite (not shown). More specifically, the positional information includes a latitude and a longitude of the host vehicle HV. Furthermore, the positional information may contain the altitude and the time. The GPS 18 is connected to the processing unit 20 and transmits the positional information to the processing unit 20.

The first camera 12 is an on-board camera. In this embodiment, the first camera 12 is mounted on the windshield of the host vehicle HV to optically capture an image of a scene ahead of the host vehicle HV. Alternatively, the first camera 12 may be a rearview camera that optically captures an image of a rear scene. The first camera 12 is connected to the processing unit 20 using serial communication and transmits image data to the processing unit 20. The image data is used by the processing unit 20 to calculate i) distances to objects, such as remote vehicles (hereinafter, referred to as “target vehicles”) TV ahead of the host vehicle HV and ii) motion information of the target vehicles TV such as velocities, acceleration, and headings.

Similar to the first camera 12, the second camera 14 is an on-board camera. In this embodiment, the second camera 14 is mounted on the windshield of the host vehicle HV adjacent to the first camera 12. Alternatively, the second camera 14 may be a rearview camera that optically capture an image of a rear scene when a review camera is also used as the first camera 12. The second camera 14 optically captures an image of a scene ahead of the host vehicle HV. The second camera 14 in this embodiment dedicatedly serves to obtain image data of target vehicles TV ahead of the host vehicle HV. More specifically, the second camera 14 obtains image data of at least one side (the rear side in this embodiment) of each target vehicle TV. The second camera 14 is connected to the processing unit 20 using serial communication, and image data of target vehicles TV captured by the second camera 14 are transmitted to the processing unit 20.

In the present embodiment, the processing unit 20 may be formed of a memory 34 and a microprocessor (a dimension estimator) 36. Although the processing unit 20 is described and depicted as one component in this embodiment, it is merely shown as a block of main functions of the system 10, and actual processors performing these functions may be physically separated in the system 10.

The memory 34 may include a random access memory (RAM) and read-only memory (ROM) and store programs therein. The programs in the memory 34 may be computer-readable, computer-executable software code containing instructions that are executed by the microprocessor 36. That is, the microprocessor 36 carries out functions by performing programs stored in the memory 34.

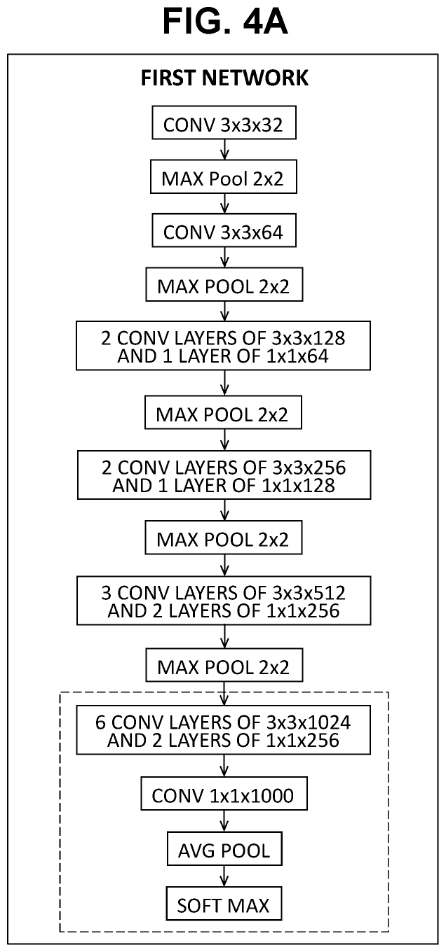

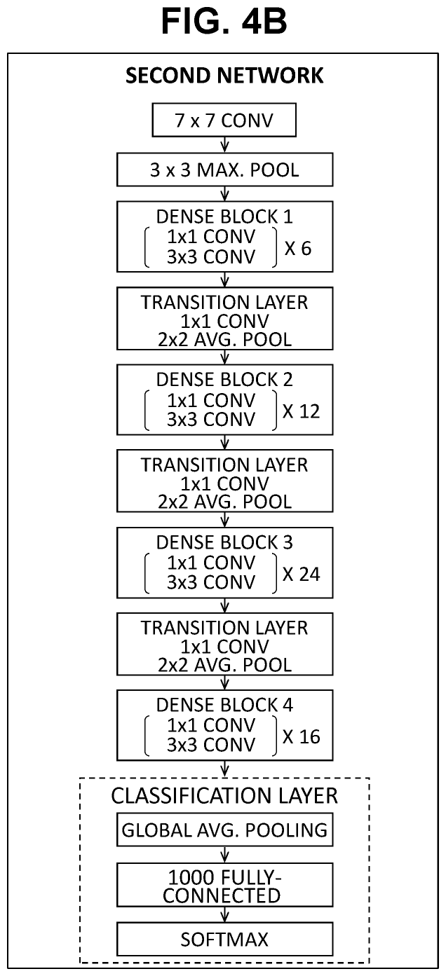

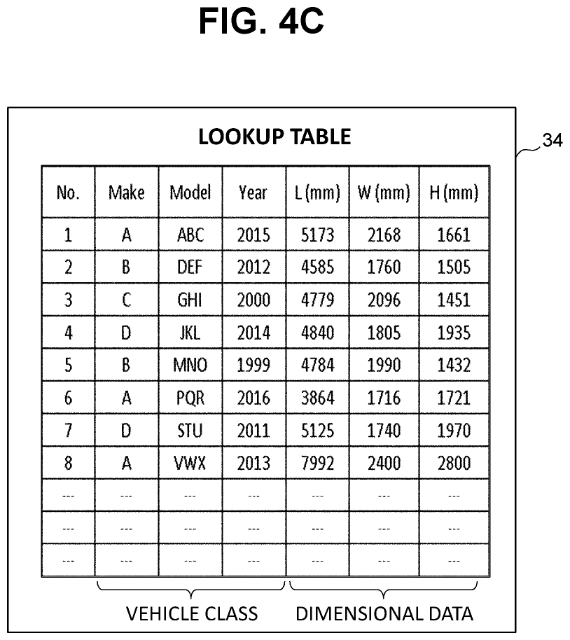

The memory 34 also stores dimensional data (dimensional information) of a variety of vehicles which have been collected in advance. As shown in FIG. 4C, the memory 34 stores a lookup table. The lookup table includes dimensional data of a variety of vehicles each of which is associated with a vehicle class. In the present embodiment, the vehicle class is identified with, e.g., “Make (manufacturer),” “Model,” and “Year”. For example, in the lookup table, the vehicle class No. 2 contains an item of “Make: A,” “Model: DEF,” and “Year: 2012” with its dimension of Length: 4585 (mm), Width: 1760 (mm) and Height: 1505 (mm).

The microprocessor 36 is configured to calculate the distance to the target vehicle TV and the motion information of the target vehicle TV as described above. Furthermore, the microprocessor 36 is configured to i) estimate a dimension of a target vehicle TV ahead of the host vehicle HV through a machine learning algorithm, ii) calculate a center position of the target vehicle TV, and iii) outputs the center position along with the dimension of the target vehicle TV to the DSRC radio 16.

In the present embodiment, the microprocessor 36 may be formed of a classifying portion 38, a determining portion 40, and a calculating portion 42. The classifying portion 38 is configured to identify the vehicle class (as described above) of the target vehicle TV through a classification process, as will be described later. The determining portion 40 is configured to determine the dimension of the target vehicle TV through a dimension extraction process based on the vehicle class identified by the classifying portion 38. The calculating portion 42 is configured to calculate the center position (i.e., latitude, longitude, and altitude) of the target vehicle TV through a center position calculating process based on the dimension determined by the determining portion 40 and the distance input from the first camera 12.

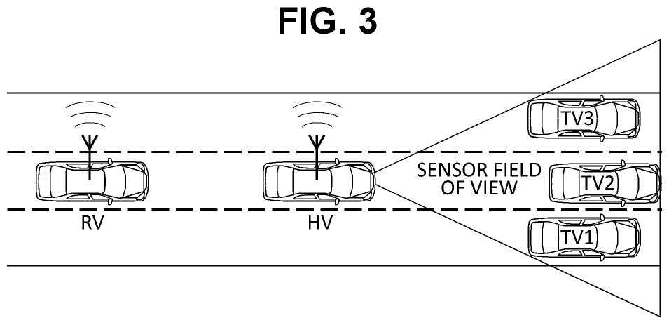

Next, the classification process, the dimension extraction process, and the center position calculating process will be described more detail. The following description is based on an exemplary scenario illustrated in FIG. 3 where the host vehicle HV equipped with the system 10 of the present embodiment detects target vehicles TV1, TV2, TV3 (may be collectively referred to as “TV”), which are not equipped with DSRC capabilities, ahead of the host vehicle HV, and shares the information regarding the target vehicles TV with another remote vehicle RV that is behind the host vehicle HV and is equipped with DSRC capabilities.

The classification process is basically based on Machine Learning (ML), more specifically, Deep Learning method.

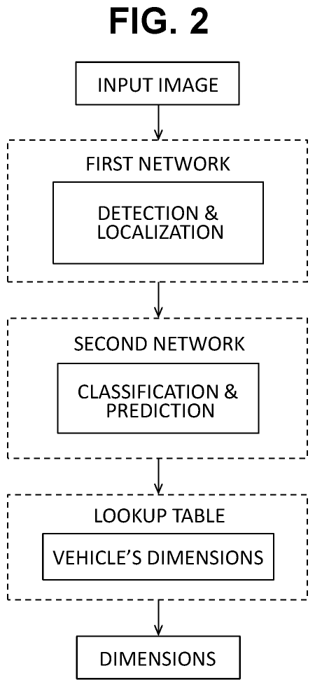

In this embodiment, You Look Only Once (YOLO) and DenseNet are used as the ML architectures. Transfer learning concept is used to train the Convolutional Network (ConvNet), where a pre-trained ConvNet is used as an initialization for current specific dataset. The earlier layers of the ConvNet are kept fixed, whereas the higher layers of the ConvNet are fine-tuned to fit current needs. This is motivated by the fact that earlier layers of a ConvNet contain more generic features (e.g., edge detectors, color blob detectors, corners, etc.), whereas the higher layers contain features specific to the dataset of current interest. As shown in FIGS. 2, 4A and 4B, the Machine Learning problem is divided into two networks: “first network” and “second network.” FIG. 4A shows the flowchart of the first network. The first network would take in the video input and run each frame in a You Only Look Once (YOLO) with 28 Convolutional layers. The first network outputs the bounding boxes for the detected vehicles. The bounding boxes are used to crop the detected vehicles. The cropped vehicles are then fed into the second network, which is a DenseNet trained on 196 classes from the Stanford dataset (see FIG. 4B). The DenseNet architecture consists of 40 layers. YOLO network divides the image into regions and predicts bounding boxes and probabilities for each region. These bounding boxes are weighted by the predicted probabilities for each region. YOLO network looks at the whole image and is very fast producing the output compared to other networks.

For Proof of Concept (PoC), 12 classes representing common vehicles in the Midwest are considered. After deciding on the vehicles, thousands of images were downloaded for each class. Also, pictures are taken to build own dataset. Images downloaded include front, rear and side view for the vehicles. The photos manually taken were all rear-view. The training process with DenseNet starts with training the network with CIFAR-10 dataset to get the initial weights of the network. Then, using the derived initial weights, the network trained on 196 classes from Stanford dataset. Finally, the network is fine-tuned using the 12 classes and tested the performance of classification using Confusion Matrix Method. The result shows that accuracy varies between 92% to 97%. The detection and classification is very fast and takes 9-12 frames per second on average.

In the dimension extraction process, the system (more specifically, the determining portion 40) calls the loo-up table stored in the memory 34 to determine the dimension of the target vehicle TV. By referring to the lookup table using the vehicle class identified by the classifying portion, the dimension of the target vehicle TV is determined (extracted) and output to the calculating portion 42 for the center position calculation.

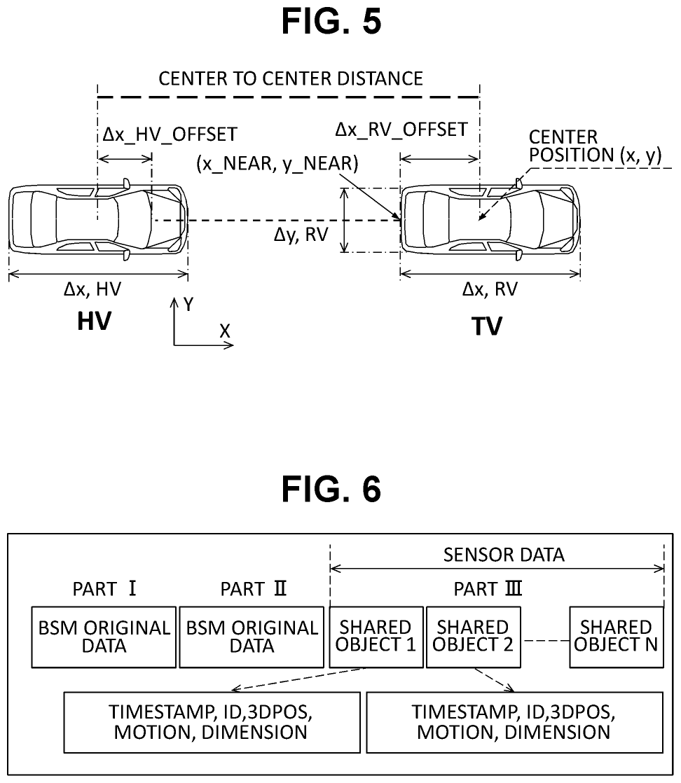

In the center position calculating process, calculation of the center position of the target vehicle TV may be performed as follows (refer to FIG. 5). The calculating portion 42 calculates the nearest point of the target vehicle TV using the distance (dotted line) obtained by the first camera 12. Then, (x_near, y_near) of the nearest point of the target vehicle TV is determined. Next, the calculating portion 42 calculates the center position of the target vehicle TV by considering the following:
The width (Δy,RV) and length (Δx,RV) of the target vehicle TV;
The offset (Δx_HV_Offset) of the first camera 12 with respect to the center position of the host vehicle HV, and the offset (Δx,RV_Offset) of the center position of the target vehicle TV with respect to (x_near,y_near).

The width (Δy,RV) and length (Δx,RV) of the target vehicle TV is contained in the dimension extracted by the determining portion 40. It should be noted that this scenario does not show the offsets in y axis because it is assumed to be zero. It should be also understood that the center position calculation method applies to the scenario when the host vehicle HV is right behind the target vehicle TV as shown in FIG. 5.

The center position (x,y) of the target vehicle TV is calculated with respect to the center position of the host vehicle HV. Then, the calculated position (x,y) of the target vehicle TV is transformed into the coordinates (Lat, Long) and shared with other vehicles via V2V and/or V2X communication.

Next, the message structure for information sharing according to the present embodiment will be described below. The structure of the DSRC message used for the present disclosure is schematically shown in FIG. 6. Basically, the new DSRC message is a modified version of the BSM defined in SAE standard J2735. In the new DSRC message shown in FIG. 6, the structure of Part I and Part II of the original BSM remain unchanged. Part III, called Sensor Data, is created and appended as an extension to the original BSM. Part III is used to host the shared sensory information. Each shared object (i.e., the target vehicles TV1, TV2, TV3) is represented using a set of attributes that best describe its status, e.g., the center position, the motion information (i.e., velocity, acceleration, heading), the dimension, etc. Each target vehicle TV is provided with an ID for tracking purpose. The time stamp at which the target vehicle TV was calculated is also shared.

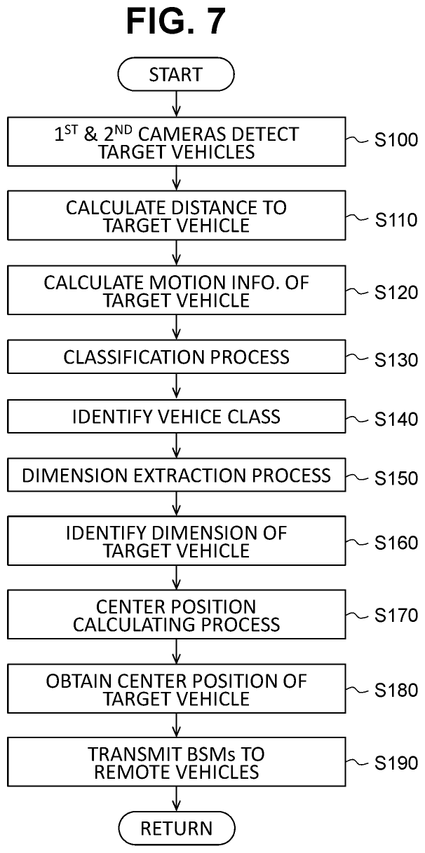

Next, operation of the system 10 according to the present embodiment will be described below with reference to FIG. 7. The system 10 (the processing unit 20) repeatedly performs the operation shown in the flowchart of FIG. 7 during travel of the host vehicle HV. In this example, it is assumed that the host vehicle HV is traveling along a lane of a road where there are three target vehicles TV1, TV2, TV3 ahead of the host vehicle HV and one remote vehicle RV with DSRC capability behind the host vehicle HV, as illustrated in FIG. 3.

When the first and second cameras 12, 14 detect the target vehicles TV (i.e., when the target vehicles TV are within the maximum recognition ranges of the first and second cameras 12, 14) at Step 100, the microprocessor 36 calculates a distance to each target vehicle TV at Step 110 based on image data captured by the first camera 12. The distances to the target vehicles TV are output to the microprocessor 36. The microprocessor 36 also calculates motion information regarding each target vehicle TV based on the image data captured at Step 120. That is, the microprocessor 36 calculates a velocity, acceleration, and a heading of each target vehicle TV. More specifically, the microprocessor 36 maintains an update cycle (every T sec), where the motion information is continuously updated. This update will continue until dimensions and the center position of the target vehicle TV are obtained.

At Step 130, the classifying portion 38 performs the classification process using the image data of the target vehicles TV through the machine learning algorism as described with FIGS. 2, 4A and 4B. Through the classification process, the class and the vehicle type of each target vehicle TV is identified at Step 140. The vehicle class (e.g., Make, Model and Year) identified are output to the determining portion 40. Next, at Step 150, the dimension extraction process is performed by the determining portion 40. In the dimension extraction process, the determining portion 40 extracts the dimension of each target vehicle TV based on the vehicle class by referring to the lookup tables stored in the memory 34. As a result, the dimension of each target vehicle TV is identified at Step 160. The dimension of each target vehicle TV is output to the calculating portion 42.

At Step 170, the calculating portion 42 performs the center position calculating process using the mathematical computing as described above. When the calculating portion 42 calculates the center position at Step 180, the center position of each target vehicle TV is output to the DSRC radio 16 together with other information (i.e., the dimension, the motion information and the positional information) at the end of the cycle. Then, the DSRC radio 16 creates BSMs containing the dimension, the center position, the positional information, and the motion information for each target vehicle TV as well as the BSM original data (see FIG. 6). At Step 190, the DSRC radio 16 transmits the BSMs through the DSRC antenna 22 to share the information of the target vehicles TV with the remote vehicle RV.

As described above, the system 10 according to the present embodiment is able to estimate the dimension of the target vehicle TV based on image data of one side (the rear side in this embodiment) of the target vehicle. Therefore, the system 10 can obtain the accurate dimension of the target vehicle TV even if only the rear side of the target vehicle TV is visible to the host vehicle HV.

Furthermore, the system 10 is able to obtain the center position of the target vehicle TV based on the dimension estimated. Therefore, the host vehicle HV is able to share the dimension and the center position of the target vehicle TV with the remote vehicle RV via the V2V communication and/or V2X communication. Accordingly, the remote vehicle RV can obtain the accurate dimensional information and the center position of the target vehicle TV even if the remote vehicle RV does not recognize (capture) the target vehicle.

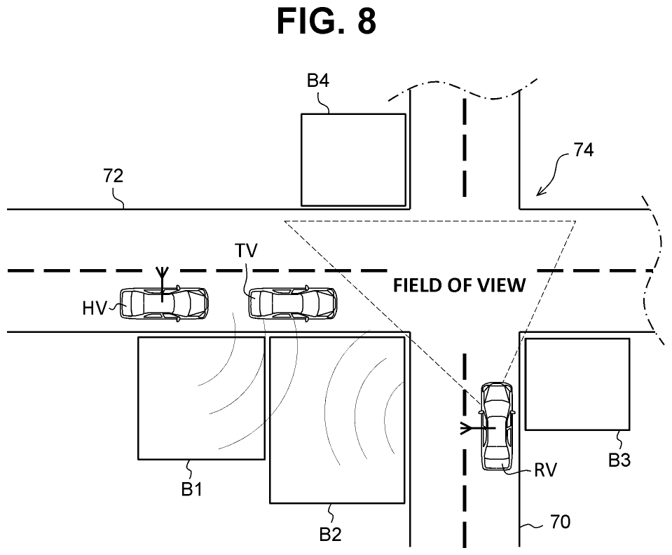

With reference to FIG. 8, it is assumed that a remote vehicle RV is travelling along one of two roads (a first road 70) constituting an intersection 74 and the host vehicle HV and a target vehicle TV ahead of the host vehicle HV is travelling along the other road (a second road 72). It is also assumed that buildings B1 to B4 exist at the intersection. Under this situation, the host vehicle HV according to the present embodiment can obtain the dimension and the center position of the target vehicle TV. Therefore, the host vehicle HV can share the information regarding the remote vehicle RV via V2V and/or V2X communication. Hence, even if the remote vehicle RV's view to the target vehicle TV is blocked by the building B2, the remote vehicle RV is able to correctly recognize the target vehicle TV with accurate information of the dimension and the center position of the target vehicle TV.

### OTHER EMBODIMENTS

In the above-described embodiment, the second camera 14 obtains image data of the rear side of the target vehicle TV and the first camera 12 obtains image data to obtain a distance to the target vehicle TV ahead of the host vehicle HV. However, the dimension of the target vehicle TV may be estimated from any side of the target vehicle TV (i.e., the front side, one of the right and left sides). For example, the second camera 14 may capture an image of a front side of the target vehicle HV, and then the system 10 may obtain the dimension of the target vehicle TV based on the image of the front side. In this case, the first camera 12 also obtains image data of a rear view and the system 10 may calculate a distance to the host vehicle behind of the host vehicle HV based on the image data obtained by the first camera 12.

In the above-described embodiment, a camera (the first camera 12) is used as a distance measuring sensor to obtain a distance to the target vehicle TV. Alternatively, other sensors, such as LiDAR, LADAR and so on, or their combination may be used to measure a distance (and motion information) to the target vehicle TV. Furthermore, the second camera 14 may be used as a distance measuring sensor. That is, the second camera 14 obtains image data of one side of the target vehicle TV, and then the second camera 14 may calculate a distance to the target vehicle TV based on image data of the target vehicle TV as with the first camera 12 in the embodiment. In this case, the first camera 12 can be eliminated, and the second camera 14 serves both as the image sensor and the distance measuring sensor.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

What is claimed is:

1. A dimension estimating system for a host vehicle, comprising:
an image sensor that obtains image data of at least one side of a target vehicle around the host vehicle; and
a dimension estimator that estimates, through a machine learning algorithm, a dimension of the target vehicle based on the image data of the one side of the target vehicle obtained by the image sensor.

2. The dimension estimating system according to claim 1, wherein
the dimension estimator includes a classifying portion and a determining portion,
the classifying portion is configured to identify a vehicle class of the target vehicle through the machine learning algorithm, and
the determining portion is configured to determine the dimension of the target vehicle based on the vehicle class identified by the classifying portion.

3. The dimension estimating system according to claim 2, further comprising
a memory that stores in a table dimensional information of a variety of vehicles each of which is associated with a vehicle class, wherein
the determining portion determines the dimension of the target vehicle by referring to the table with the vehicle class identified by the classifying portion.

4. The dimension estimating system according to claim 1, wherein
the dimension estimator calculates a center position of the target vehicle based on the dimension estimated by the dimension estimator and a distance to the target vehicle.

5. The dimension estimating system according to claim 4, wherein
the distance to the target vehicle is calculated based on the image data obtained by the image sensor.

6. The dimension estimating system according to claim 4, further comprising
a distance measuring sensor that obtains data to measure the distance to the target vehicle.

7. The dimension estimating system according to claim 6, wherein
the distance measuring sensor is at least one of a camera, a LiDAR, and a RADAR.

8. The dimension estimating system according to claim 4, further comprising:
a receiver that is configured to receive messages transmitted from a remote vehicle around the host vehicle over Vehicle-to-Vehicle (V2V) communication and/or Vehicle-to-Infrastructure (V2X) communication; and
a transmitter that is configured to transmit messages to the remote vehicle over the V2V communication and/or the V2X communication, wherein
the messages transmitted from the transmitter contain the center position and the dimension of the target vehicle calculated by the dimension estimator.

9. The dimension estimating system according to claim 8, wherein
the messages further contain motion information of the target vehicle.

10. The dimension estimating system according to claim 1, wherein
the image sensor obtains the image data of a rear side of the target vehicle ahead of the host vehicle, and
the dimension estimator estimates the dimension of the target vehicle based on the image data of the rear side.

11. A method for estimating a dimension of a target vehicle around a host vehicle, the method comprising:
obtaining, with an image sensor, image data of at least one side of the target vehicle; and
estimating, with a dimension estimator, a dimension of the target vehicle based on the image data of the one side of the target vehicle using a machine learning algorithm.

12. The method according to claim 11, wherein
estimating the dimension includes identifying, with an classifying portion, a vehicle class of the target vehicle through the machine learning algorithm and determining, with a determining portion, the dimension of the target vehicle based on the vehicle class identified.

13. The method according to claim 12, wherein
determining the dimension includes referring to a table that is stored in a memory and has dimensional information of a variety of vehicles each of which associated with a vehicle class.

14. The method according to claim 11, further comprising:
obtaining a distance to the target vehicle from the host vehicle, and
calculating, with the dimension estimator, a center position of the target vehicle based on the dimension estimated and the distance to the target vehicle.

15. The method according to claim 14, wherein
the distance to the target vehicle is calculated based on the image data obtained by the image sensor.

16. The method according to claim 14, wherein
the distance to the target vehicle is measured based on data obtained by a distance measuring sensor.

17. The method according to claim 16, wherein
the distance measuring sensor is at least one of a camera, a LiDAR, and a RADAR.

18. The method according to claim 14, further comprising:
transmitting, with a transmitter, messages to the remote vehicle over Vehicle-to-Vehicle (V2V) communication and/or Vehicle-to-Infrastructure (V2X) communication, wherein
the messages contain the center position and the dimension of the target vehicle.

19. The method according to claim 18, wherein
the messages further contain motion information of the target vehicle.

20. The method according to claim 11, wherein
obtaining with the image sensor includes obtaining the image data of a rear side of the target vehicle ahead of the host vehicle, and
estimating with the dimension estimator includes estimating the dimension of the target vehicle based on the image data of the rear side.
